(19) United States
(12) Patent Application Publication
(10) Pub. No.: US 2005/0016331 A1
(43) Pub. Date: Jan. 27, 2005

(54) Protective sleeve for use with extension bar

(76) Inventor: Bobby Hu, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/814,566

(22) Filed: Mar. 31, 2004

(30) Foreign Application Priority Data
Jul. 21, 2003 (TW) 92119782

(51) Int. Cl. B25B 23/16

(52) U.S. Cl. 81/177.2

(57) ABSTRACT

A protective sleeve is provided for use with an extension bar. The extension bar includes a detent and a button that can be pressed in order to control the detent. The protective sleeve defines a hole and an aperture communicated with the hole. The hole receives the extension bar when the aperture receives the button.

### FIELD OF INVENTION

The present invention relates to a protective sleeve for use with an extension bar.

### BACKGROUND OF INVENTION

An extension bar 1 includes a shank 2 and a square insert 6 projecting from the shank 2. A button 3 is put in the shank 2. A portion of the button 3 extends from the shank 2. A detent 4 is embedded in the square insert 6. A portion of the detent 4 extends from the square insert 6. A mechanism (not shown) is arranged between the button 3 and the detent 4 so that when the button 3 is pushed, the detent 4 is allowed to completely enter the square insert 6. Therefore, a user will have his or her fingers hurt by the button 3 if the extension bar 1 is accidentally rotated before the user takes his or her hand off the extension bar 1.

The present invention is therefore intended to obviate or at least alleviate the problems encountered in prior art.

### SUMMARY OF INVENTION

The primary objective of the present invention is to protect the hands of a user when using an extension bar.

According to the present invention, a protective sleeve is provided for use with an extension bar. The extension bar includes a detent and a button that can be pressed in order to control the detent. The protective sleeve defines a hole and an aperture communicated with the hole. The hole receives the extension bar when the aperture receives the button.

Other objects, advantages, and novel features of the invention will become more apparent from the following detailed description when taken in conjunction with the attached drawings.

### BRIEF DESCRIPTION OF DRAWINGS

The present invention will be described through detailed illustration of the preferred embodiment referring to the attached drawings.

FIG. 1 is a side view of a conventional extension bar.

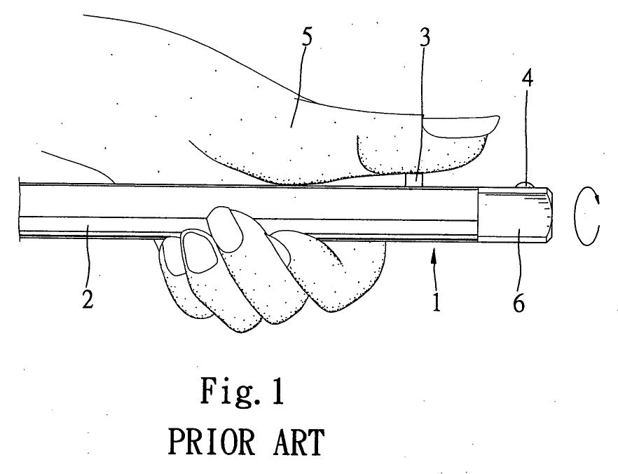

FIG. 2 is a perspective view of an extension bar with a protective sleeve according to the preferred embodiment of the present invention.

FIG. 3 is similar to FIG. 2 but shows the protective sleeve removed from the extension bar.

FIG. 4 is a cross-sectional view of the protective sleeve of FIG. 2.

FIG. 5 is another cross-sectional view of the protective sleeve show in FIG. 2.

FIG. 6 is a side view of the protective sleeve and the extension bar of FIG. 2 held by a user's hand.

FIG. 7 is similar to FIG. 6 but shows the user's thumb pressing a button.

### DETAILED DESCRIPTION OF PREFERRED EMBODIMENT

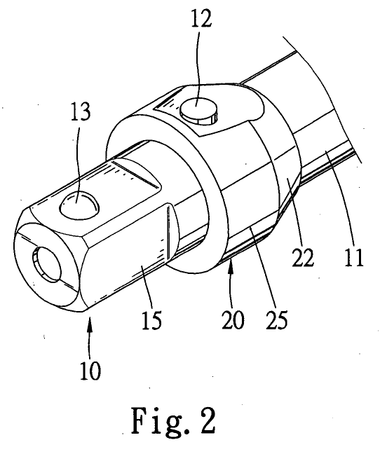

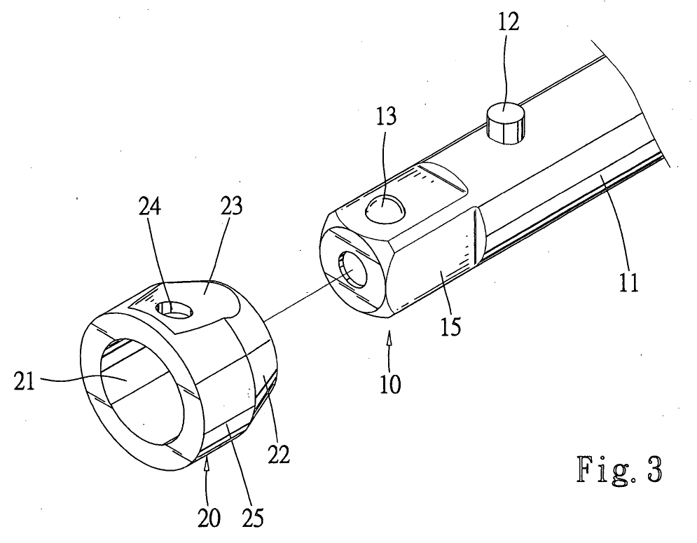

Referring to FIGS. 2 and 3, an extension bar 10 and a protective sleeve 20 are shown. The extension bar 10 includes a shank 11 and a square insert 15 projecting from the shank 11. A button 12 includes a first portion extending into the shank 11 and a second portion normally extending from the shank 11. The square insert 15 includes four facets formed thereon. A detent 13 includes a first portion put in one of the facets and a second portion normally extending from that facet unless pressed. The square insert 15 can be inserted into a square hole defined in a socket (not shown). How the button 12 cooperates with the detent 13 will not be described in detail for being conventional.

The protective sleeve 20 includes a hole 21 defined in an axial direction so that the shank 11 can go through the hole 21 so that the protective sleeve 20 can be attached to the extension bar 10. The periphery of the protective sleeve 20 consists of a cylindrical portion 25 and a frustum-shaped portion 22 connects smoothly with the periphery of the shank 11. The protective sleeve 20 includes a recess 23 defined in the periphery. Within the recess 23, the protective sleeve 20 includes an aperture 24 communicated with the hole 21. The aperture 24 is used for receiving the button 12.

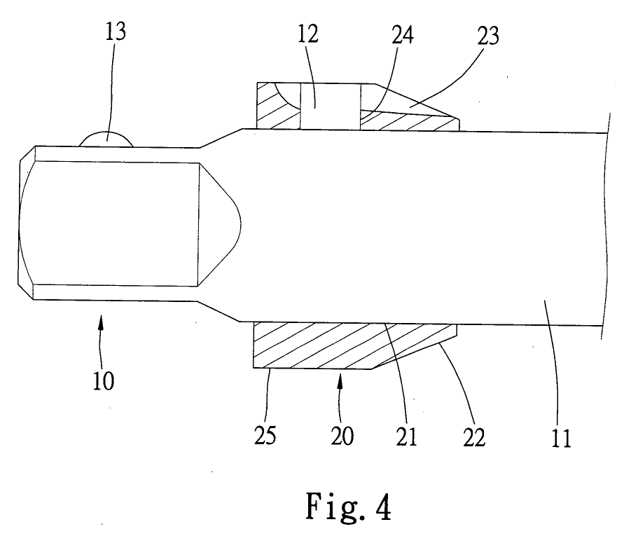

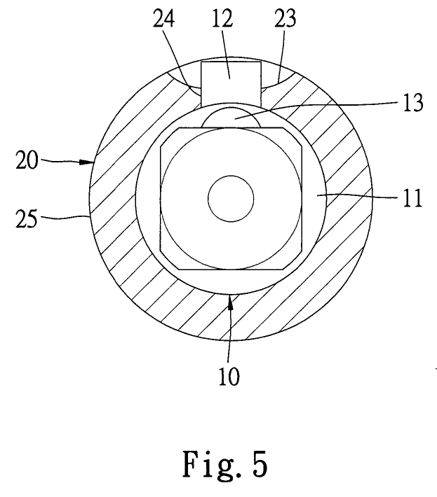

Referring to FIGS. 4 and 5, the recess 23 encompasses the button 12. A height of the second portion of the button 12 is no greater than a thickness of the protective sleeve 20. Therefore, the button 12 does not protrude beyond the protective sleeve 20.

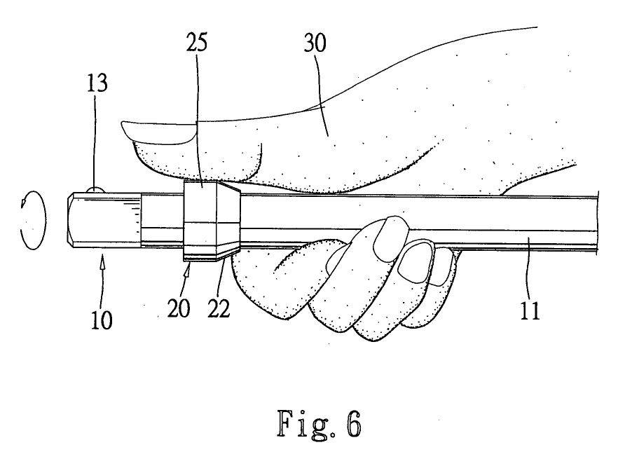

Referring to FIG. 6, the button 12 is surrounded by means of the protective sleeve 20. Hence, a user will not push the button 12 by accident. Moreover, the user will not have his or her hand hurt by the button 12.

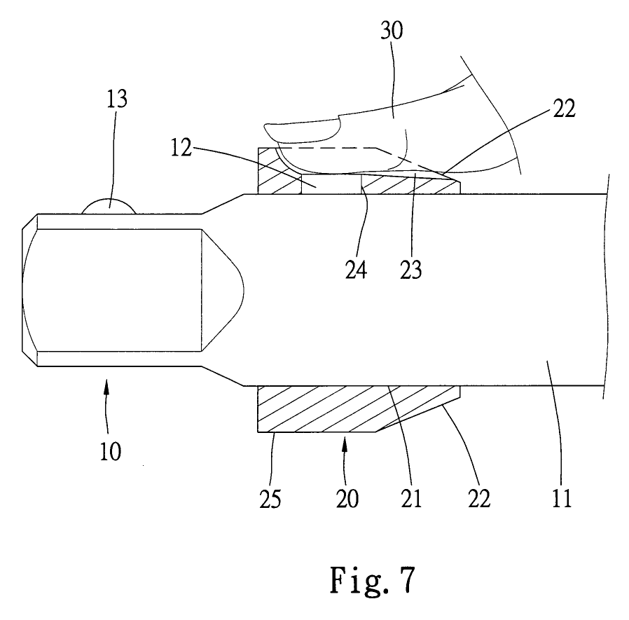

Referring to FIG. 7, the recess 23 encompasses the user's thumb 30 so that the user feels comfortable when pressing the button 12. The frustum-shaped portion 22 of the periphery of the protective sleeve 20 connects smoothly with the periphery of the shank 11 so that movement of the user's hand from the shank 11 to the protective sleeve 20 can be smooth and quick.

The present invention has been described through detailed illustration of the preferred embodiment. Those skilled in the art can derive variation from the preferred embodiment without departing from the scope of the present invention. Therefore, the preferred embodiment shall not limit the scope of the present invention defined in the claims.

1. A protective sleeve for use with an extension bar comprising a detent and a button for controlling the detent, the protective sleeve defines a hole and an aperture communicated with the hole, wherein the hole receives the extension bar when the aperture receives the button.

2. The protective sleeve according to claim 1 defining a recess for receiving a user's finger, wherein the aperture is located within the recess.

3. The protective sleeve according to claim 1 comprising a thickness greater than the height of the button.

4. The protective sleeve according to claim 1 comprising a periphery with a conical portion and a frustum-shaped portion sloping from the conical portion, wherein the frustum-shaped portion of the periphery of the protective sleeve slopes to the periphery of the extension bar as the protective sleeve is put on the extension bar.
